(19) United States
(12) Patent Application Publication
(10) Pub. No.: US 2020/0253017 A1
(43) Pub. Date: Aug. 6, 2020

(54) METHOD FOR CONTROLLING A LIGHTING DEVICE, AND LIGHTING DEVICE

(71) Applicant: TECHNISCHE UNIVERSITÄT DARMSTADT, 64289 Darmstadt (DE)

(72) Inventors: Tran Quoc KHANH, Frankfurt am Main (DE); Trinh Quang VINH, Darmstadt (DE)

(73) Assignee: TECHNISCHE UNIVERSITÄT DARMSTADT, 64289 Darmstadt (DE)

(21) Appl. No.: 15/769,755

(22) PCT Filed: Oct. 11, 2016
(86) PCT No.: PCT/EP2016/074361

§ 371 Date: Jun. 12, 2018

(30) Foreign Application Priority Data
Oct. 20, 2015 (DE) 10 2015 117 852.4

(51) Int. Cl. H05B 45/28; H05B 47/105

(52) U.S. Cl. CPC H05B 45/28; H05B 47/105

(57) ABSTRACT

In a method for controlling a lighting device having at least two illuminants with different emission characteristics, in a detection step, at least one actual temperature value, and, during a predeterminable detection period, at least one temperature-change information are detected, in a control-signal generating step dependent upon the at least ore detected actual temperature value and the at least one temperature-change information, new control signals are determined for the respective control of the at least two illuminants for the emission of a predetermined spectral power distribution are determined with the lighting device and in a control step, the new control signals are transmitted to an operating device by which the operating current for each illuminant is provided, in order to keep the spectral power distribution emitted by the lighting device possibly constant dining operation of the lighting device. In the detection step, an average operating temperature of the at least two illuminants can be detected as an actual temperature value or an operating temperature can be detected for each illuminant as the actual temperature value of the respective illuminant.

### BACKGROUND AND SUMMARY

The invention relates to a method for controlling a lighting device with at least two illuminants having different emission characteristics.

A large variety of lighting means is known, which can generate and emit light in different ways. In the case of incandescent lamps an electrical conductor is heated via an electric current flow, and is excited to glow or light. The emission spectrum of an incandescent lamp can predetermined on the one hand, via a suitable material selection and dimensioning of the filament flown-trough by current, and, one the other hand, via a design or coating of an envelope surrounding the filament.

With a light-emitting diode, a light-emitting semiconductor component, an electric current can be converted very efficiently into a light emission. By selecting the semiconductor materials used for the light-emitting diode and their doping, the spectral characteristics of the light generated with the respective light-emitting diode can be influenced. The light emitted by the semiconductor material usually has a very small and nearly monochromatic wavelength range. By combining the light-emitting semiconductor material with luminescent materials, a short-wavelength, and therefore high-energy light, radiated by the semiconductor material can be converted into longer-wavelength light, and a broad-band emission spectrum can be generated.

Various types of light-emitting diodes are known, which differ from one another in terms of the respective emission characteristics, but also in terms of other optical characteristics, such as for example the light yield or the opening angle of the light emission, as well as in terms of efficiency, the operating current, and a temperature dependence. In addition, there are further different characteristics, such as for example the ageing of the light-emitting diode depending on the operating hours, the operating conditions and the respective semiconductor material.

It is known that a variety of multiple light-emitting diodes with different emission characteristics can be grouped in a lighting device, in order to be able to generate a distribution of spectral power emitted by the lighting device, with possibly advantageous properties by superimposing the various emission characteristics. In order to be able to generate a distribution of spectral power, which is as similar as possible to natural daylight, usually red, blue, green and also broadband emitting white light-emitting diodes must be combined with one another. Through a separate control, the light intensity of the individual light-emitting diodes, and thereby accompanying, the light spectrum emitted by superimposing of all light-emitting diodes can be preset.

The human eye has a highly-developed sense of color, and can differentiate various light spectra from one another, as well as differentiate the perception of color of products, which are illuminated with various light spectra or with various spectral power distributions. It is known that various light spectra are in each case particularly advantageous for different applications. Thus, lighting devices with different light spectra, for example in a grocery store, can be used to illuminate a cheese product counter in advantageous yellow tones, a meat products counter in advantageous red tones, and a fruit and vegetable counter in green tones. The respective light spectrum of the lighting devices used is of great importance also for the illumination of museums, or when creating film footage.

The emission characteristics of a light-emitting diode are mainly due to the respective construction, by the material, and the production and are approximately the same for light-emitting diodes of identical construction. Multiple lighting devices, which comprise an identical combination of light-emitting diodes, as well as a same control device, accordingly emit an approximately identical light spectrum during operation. In order generate to a light spectrum with a predetermined color temperature, the individual light-emitting diodes, in the control device of the lighting device, are controlled or usually supplied with a pulse-width modulated current in such a manner that the superimposition of the various light spectra of the individual light-emitting diodes produce, the desired color temperature impression.

It is known from practice to use mathematic models of the light spectra of the individual types of light-emitting diodes for the control of the individual light-emitting diodes. Most models are based on physical considerations and approximations, wherein the light spectrum is composed of multiple components, and the respective component parameters are adapted to a light spectrum measured with the relevant light-emitting diode type. With such models, the light spectra of a light-err-kitting diode type can, in predetermined operational conditions, be modeled relatively well and with sufficient exactness for many applications.

However, it has been shown that the light spectra emitted by the individual light-emitting diodes are not only dependent upon the respective material composition and construction of the semiconductor, but also dependent upon further parameters and, in particular, upon the operating temperature of the light-emitting diode. Here, a peak-wavelength of a light-emitting diode, for example, can change by multiple nanometers and, if necessary, by around 10 it or more, if the temperature rises by 40° C. In the same fashion, the peak-wavelength also changes in a current flow of between 100 milliamperes and 700 milliamperes, wherein these current values lie within a range conventionally used for controlling of the light-emitting diodes. In addition, the light intensity of the light-emitting diodes, changes in both cases. This results in that, during the operation of the lighting device, due to a changing operating7 temperature of the light-emitting diodes, the light spectrum of the lighting device generated by the superimposition of the individual light-emitting diodes, and in particular its color temperature, change. A correction is made difficult in that, in a current flow altered in order to compensate the temperature effect through a light-emitting diode, the light spectrum of the light-emitting diode is likewise altered.

If the ambient temperature changes during the operation of the lighting device, this leads to a corresponding warming or cooling of the individual light-emitting diodes, and to an alteration of the hat spectrum radiated by the respective fight-emitting diodes resulting therefrom. A temperature monitoring and temperature control of the lighting device would be very elaborate and costly.

It is currently hardly possible to operate a lighting, device with multiple various light-emitting diodes such that the color temperature of the light spectrum emitted by the lighting device remains as constant as possible during operation.

It is desirable to design and operate a lighting device such that the light spectrum emitted with the lighting device during the operation of the lighting device remains as constant as possible, even with changing, temperatures.

According to the invention, a method is provided for controlling a lighting device, which comprises at least two illuminants with different emission characteristics, wherein, in a detection step, at least one actual temperature value, and, during a predeterminable detection period, at least one temperature-change information are detected, wherein, in a control-signal generating step dependent upon the at least one detected actual temperature value and the at least one temperature-change information, new control signals for the respective control of the at least two illuminants for the emission of a predetermined spectral power distribution with the lighting device are determined, and wherein, in a control step, the new control signals are transmitted to an operating device, with which the operating current for each illuminant is provided, in order to keep the spectral power distribution emitted by the lighting device as constant as possible during the operation of the lighting device.

A completely constant light emission can hardly ever be achieved, in practice, and, if necessary, only with an economically non-reasonable design effort. That is why, in terms of the invention, an alteration of the light emission or the spectral power distribution, which is smaller than a predeterminable threshold value for a color change, is referred to as possibly constant or as a constant light emission, insofar as the upper limit predetermined by the threshold value is below or at the edge of human perception.

Based on the actual temperature value detected in the detection step, an alteration of the control signals adapted to the measured actual temperature value can be caused, the new control signals for the individual illuminant can be determined, and the new control signals can be transmitted to the operating device.

Specifying, the new control signals can lead to the electrical power supplied to the individual illuminant being changed, which can affect the illuminant' operating temperature, and can change this operating temperature. The duration and amount of the change of the operating temperature, which is affected by a change of the control signals and a thereby altered electrical power consumption of the illuminant, could, via simulations and measurements, be estimated and considered when specifying new control signals.

Additionally, alterations of an ambient temperature outside of the lighting device, as well as for example via an altered solar irradiation of the lighting device, above all within the lighting device, can, via changes of the ambient temperature caused by a heat-up of a housing or of individual components of the illuminant, lead to an additional alteration of the operating temperature and of the light spectra and light intensity radiated from the illuminant.

In order to be able to take into account this influence of a changing ambient temperature, unforeseeable and therefore not detectable in advance, and to be able to use said influence for a possibly precise and fast adaptation of the control signals, not only the actual temperature value, but in addition also a change over time, for example of the ambient temperature or the actual operating temperature of the illuminants are detected during the detection period, and this change over time is considered in the determination of the parameters of the control signals or in the specification of the new control signals. In the specification of new control signals, a prognosis is consequently determined in advance about the change over time of the temperature occurring after the detection period, and taken into account for the determination of the new control signals. The light emission of the lighting device can thus be particularly fast and precisely adapted to changing temperatures, and can be kept as constant as possible.

With the method according to the invention, the light emission of a lighting device, which, for example, as intended, is to be often operated outdoors, and is to be employed for the illuminating of film footage or outdoor shootings of pictures, despite the changes of the ambient temperature resulting over the course of the day can be kept particularly constant. In addition, comparatively rapid temperature changes can also be taken into account, which result, for example, through a frequently changing solar radiation on a cloudy day, and thereby-caused warming and cooling of the lighting device.

Alterations of the ambient temperatures, which are eventually caused by incidental solar radiation, or by an artificial heating or cooling device, can have its effect on the lighting device also in an operation of the lighting device in buildings or closed rooms, and these alterations can be taken into account when specifying new control signals, in order to maintain the emission of the lighting device as constant as possible, despite changing temperatures.

In order to be able to detect a possibly meaningful actual temperature value with simple means in the detection step, it is provided for that in the detection step, an operating temperature of the at least two illuminants is detected as the actual temperature value. A commercially available, cost-effective, and very small temperature sensor can be used for this purpose. The one temperature sensor can be arranged spatially near to the illuminant such that the temperature sensor detects an average operating temperature of the various illuminants. It is likewise possible to arrange the one temperature sensor such that the operating temperature of the illuminant(s) is detected, which are known to have the greatest dependence of light-emission from the operating temperature.

A particularly precise detection of initial values for the adaptation of the control signals can according to the invention occur in that, in the detection step for each illuminant, an operating temperature is detected as an actual temperature value of the relevant light means. In this manner, differences of the operating temperature for the individual illuminants can be detected and taken into account. These differences can, for example, be caused by a difference in power consumption and corresponding heat dissipation of the individual illuminants, whose share of the light emission, depending on the predetermined light spectrum, which is to be emitted by the lighting device, can be of different magnitude from illuminant to illuminant. Further differences can, due to design, be caused in that an illuminant is surrounded by other illuminants, and is thus more heated during operation than an illuminant arranged outside. Depending on the ambient temperatures, illuminants arranged near to a housing outer side, or by chance facing a solar irradiation can be heated more strongly than other illuminants of the lighting device. Through the detection of distinct operating temperature for the individual illuminants, the above-explained influences can be very precisely detected and taken into account.

It is possible that the lighting device only comprises one single illuminant each per type of illuminant. In this case, each illuminant can be assigned a separate temperature sensor. It is likewise possible that the lighting device respectively comprises multiple similar illuminants per type of illuminant. Then, each type of illuminant, and therefore multiple similar illuminant, expediently also arranged as to closely neighbor one another can be assigned a single temperature sensor. Each illuminant, independently of the respective type of illuminant and the arrangement thereof, can also have a separate temperature sensor assigned and evaluated.

While the altering of the operating temperature, which is caused via an altering of the control signals, can often be determined and considered relatively precisely via previously-performed measurements or simulations, previously unknown changes of the ambient temperature can not be anticipated, and therefore not considered in advance for the alteration and adaptation of the control signals. In order to be able to detect this previously unknown alteration of the ambient temperature as well as possible in this detection step, it is provided according to an advantageous configuration of the inventive concept, that in the detection step, an alteration of the ambient temperature, during the detection period, is detected as a temperature-change information. In order to be able to detect the ambient temperature with a temperature sensor, and here, to be influenced by the heat dissipation of the illuminants during the operation as little as possible, it can be provided to arrange the temperature sensor as far away as possible, or on a side within the housing of the lighting device facing away from the illuminants. The temperature sensor can instead also be arranged on an outer side of the housing.

It is likewise possible that the actual alteration of the temperature detected within the detection period allows for a good prognosis for the adaptation of the control signals. It is therefore likewise possible that, additionally or alternatively to the detection of the alteration of the ambient temperature, an alteration of at least one operating temperature of the illuminants is detected as a temperature-change information during the detection period, in the detection step.

According to an advantageous configuration of the inventive concept is provided that, in the control-signal-generating step, a start parameter is retrieved from a storage device depending on the at least one actual temperature value for each illuminant, that for each start parameter, based on the at least one temperature-change information, a correction parameter can be determined and that, from the start parameter and the correction parameter, the new control signals for the respective illuminant are generated. The start parameters can, through simulations and measurements, have been detected in advance depending on a temperature, and have been stored in the storage device. Here, the start parameters represent a first initial value for the detection of the new control signals. This initial value can, with suitable approximation methods, be determined in advance for different actual temperature values, and can be stored in the storage device. Here, the different start parameters can be detected, either depending on a single actual temperature values, or depending on a number of actual temperature values, in case distinct temperature sensors are respectively used for multiple illuminants and can be read.

With suitable parametrization methods, start parameters, based on a number of previously measured supporting points, can be determined for different actual temperature values, or for successive actual temperature value ranges. It has been found to be particularly advantageous when, for each wavelength range with a Taylor series expansion, a spectral emission model is respectively calculated depending on the actual temperature value, on the basis of which spectral emissive model the start parameters for the control of the illuminants are determined. With a Taylor series expansion, parameters for a precise model of the light spectra of the individual illuminant, or, if necessary, light-emitting diodes can, with a small number of supporting points of the temperature, and, on the assumption of an approximately linear dependency of the light spectra in the vicinity of a supporting point temperature value be detected with low effort and without using physical explanatory models, be converted into start parameters for the control signals, and can be stored in the storage device.

It has been shown that, in a suitable test bench for the spectral detection of the illuminants used in a lighting device, depending on the operating temperature and on the operating current within the areas provided for the operation, just a few minutes can be sufficient. The subsequent parametrization can, in the test bench, likewise be carried out within few minutes with a sufficiently high-performance data processing device. The start parameters generated in this manner can be transferred into the storage device of the lighting device, and be stored there, before the lighting device is removed from the test bench.

With an increasing number of supporting point temperature values, the required storage increases considerably in the case that multiple different illuminants have to be controlled, and respectively distinct actual temperature values should be detected and evaluated for the variety of illuminants. Since the new control signals are not only determined from the start parameter, but additionally a correction parameter, is taken into account, the number of supporting points for which start parameters are determined by means of approximation methods and stored in the storage device, can be considerably reduced, without the spectral power distribution being subject to considerable variations or deviations from the predetermined spectral power distribution.

According to a particularly advantageous embodiment of the inventive concept, it is provided for the correction parameter to be determined in the signal generating step by means of a mathematical approximation method, in which a proportional fraction and an integral fraction are used in the approximation method for determining the correction parameter. Here, the proportional fraction can be determined depending on a temperature difference ΔT, which is calculated as a difference of the actual temperature value and the closest supporting point temperature value. The integral fraction can likewise be determined depending on the temperature difference ΔT, wherein the change over time of this temperature ΔT throughout the detection period is considered and evaluated The correction parameter referred to as Δpwm can therefore be calculated as follows:

Δpwm=P*ΔT(t=t0)+I∫ΔT(t)dt,

with P designating a proportional fraction parameter, I designating an integral fraction parameter, with ΔT(t=t0) designating the temperature difference between the actual temperature value and the supporting point temperature value, and with ΔT(t) indicating the change in temperature related to the temperature value depending on the time t during the detection period. The integral fraction may in this case either consider an individual temperature-change information or a small number of temperature-change values or also consider a course over time of the temperature change during the detection period by a corresponding integration and take it as a basis for determining the integral fraction.

According to one embodiment of the inventive concept, it is provided for a proportional fraction parameter and an integral fraction parameter to be determined b means of a simulation performed in advance, which parameters are used in the approximation method for determining the proportional fraction and the integral fraction. In this way, the proportional fraction parameter P and the integral fraction parameter I can be determined in advance by means of a number of simulations, in which in each case new control signals are determined for a variety of supporting point temperature values and temperature differences ΔT, and the spectral power distributions resulting for the new control signals are evaluated. Expediently, the proportional fraction parameter P and the integral fraction parameter I are each constant values.

According to a particularly advantageous configuration of the method according to the invention, it is provided that in a selection step, the light spectrum of the lighting device is selected among a number of light spectra defined in advance and is predetermined thy a subsequent operating time. In this way, a number of light spectra with different color temperatures can be predefined and made available fora selection by means of the user. Among three or four color temperatures, for example, the user can then select the color temperature which appears to be particularly suitable for the intended purpose in the individual case. By predefining a number of preconfigured light spectra, use and adjustment by the user is simplified,

It is also possible to grant a user the option to predefine a freely-configurable light spectrum, which is generated by means of the multiple illuminants by a suitable control of the illuminants and by superimposition of the individual light spectra. This way, the user can adjust the light spectrum emitted with the lighting device individually to completely different applications, and is not reliant and restricted to select a predefined light spectrum. The lighting device may comprise suitable input means and display the respective predefined light spectrum by means of a display device. It is also possible to provide an interface to the storage device in order to be able to save the light spectrum selected by a user or the parameters relevant therefore there.

The invention also relates to a lighting device, by means of which a possibly constant light spectrum can be emitted over a possibly long period of time. For this purpose, the lighting device according to the invention comprises at least two illuminants with different emission characteristics, at least one temperature sensor, a memory device and a control device comprising a microprocessor, wherein the control device can read start parameters from the memory device of the lighting device, determine a correction parameter depending on at least one temperature change information measured by means of the temperature sensor and transform the start parameters and the correction parameters into new control signals, and transmit these new control signals to an operating device of the lighting device, by means of which the operating current for each illuminant is provided, in order to keep the light spectrum emitted by the lighting device as constant as possible during operation of the lighting device.

A commercially-available, cost-effective and very small temperature sensor can be used as the temperature sensor. An individual temperature sensor can be arranged in the vicinity of the illuminants, so that the temperature sensor detects an average operating temperature of the variety of illuminants. It is also possible to arrange the one temperature sensor such, that the operating temperature, of the illuminant(s) is detected, which are known to have the greatest dependence of light-emission on the operating temperature.

Furthermore, it can be provided to arrange the temperature sensor as far away as possible, or on a side facing away from the illuminants within the housing of the lighting device. The temperature sensor can likewise be arranged on an outer side of the housing instead.

According to an advantageous embodiment of the inventive concept, it is provided that the lighting device comprises an operating temperature sensor for each illuminant and assigned to this illuminant. It is possible for the lighting device to comprise in each case only one single illuminant per illuminant type. In this case, each of the illuminants may be assigned a separate operating temperature sensor, which is arranged close to the respective illuminant and substantially detects the operating temperature thereof. It is also possible for the lighting device to comprise in each case multiple similar illuminants per illuminant type. If so, each type of illuminant and therefore multiple similar illuminants expediently arranged as to closely neighbor one another can have assigned a single operating temperature sensor. Also, each illuminant can have a separate operating temperature sensor assigned and evaluated, irrespective of the respective illuminant type and the arrangement thereof.

In order to be able to generate a possibly large variety of light spectra accurate in every detail by superimposition of in predetermined light spectra of the respectively used illuminants, it is provided for the lighting device to comprise more than three different light-emitting diodes and among these, at least one light-emitting diode having a luminescent wavelength converter as the illuminant.

### BRIEF DESCRIPTION OF THE DRAWINGS

The inventive concept is explained in greater detail below with reference to several exemplary embodiments. The Figures show in:

FIG. 1 a schematic illustration of spectral power distributions for various light-emitting diodes with two different operating temperatures,

FIG. 2 a schematic illustration of a spectral power distributions of a lighting device comprising a variety of different light-emitting diodes, with two different operating temperatures, and

FIG. 3 a schematic illustration of a lighting device according to the invention with multiple illuminants and with an operating temperature sensor, and

FIG. 4 a schematic illustration of a differently-configured lighting device with multiple illuminants and with an ambient temperature sensor, and

FIG. 5 a schematic illustration of an illuminant carrier of a lighting device, the carrier having multiple illuminants and a respectively-assigned operating temperature sensor arranged thereon.

### DETAILED DESCRIPTION

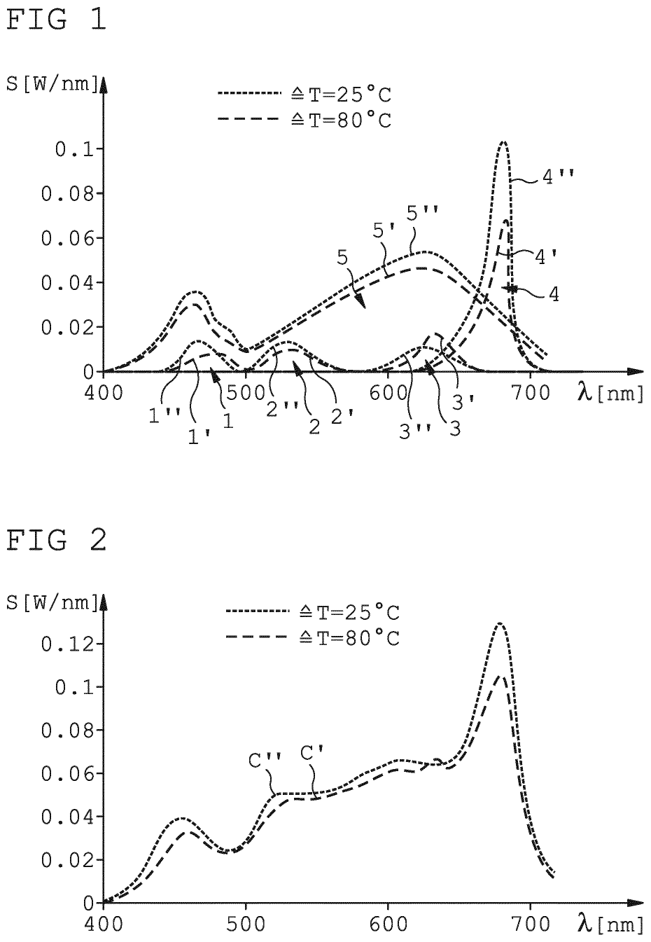

FIG. 1 schematically shows, for various light-emitting diodes, the spectral power distribution depending on the emitted wavelength for two temperatures, with the dotted lines in each case showing the spectral power distribution at 25° C. and the dashed lines showing the spectral power distribution at 80° C. Shown by way of example here are the spectral power distributions 1′ and 1″ of a blue light-emitting diode 1, the spectral power distributions 2′and 2″ of a green light-emitting diode 2, the spectral power distributions 3′ and 3″ of a first red light-emitting diode 3, the spectral power distributions 4′ and 4″ of a second light-emitting diode 4 as well as the spectral power distributions 5′ and 5″ of a white light-emitting diode 5 emitting a broadband white-light spectrum, wherein the white light-emitting diode 5 comprises a luminescent wavelength convener as the illuminant. It can be seen that a peak wavelength in all light-emitting diodes 1 to 5 shifts towards a higher wavelength as the temperature increases. Except for the first red light-emitting diode 3, the spectral power distribution decreases in the region of the respective peak wavelength as the temperature decreases,

A similar change of the spectral power distribution can also be determined and measured for each light-emitting diode 1 to 5 depending on the operating current. In addition, with an increasing operating current of a light-emitting diode 1 to 5, the operating temperature increases as well, since the power supplied with the operating current can be comparatively efficient, but can not completely be converted to light emission and, inevitably, also at least a low heat radiation occurs, due to which the operating temperature of light-emitting diodes 1-5 is increased.

FIG. 2 illustrates the respective total emission spectra G′ and G″ for the two temperatures 25° C. and 80° C., which result from a superimposition of the individual light emissions of the various light-emitting diodes 1 to 5, illustrated in FIG. 1. Similar to FIG. 1, the dotted line G″ shows the spectral power distribution at 25° C., and the dashed line G′ shows the spectral power distribution at 80° C. It can be seen that in almost every wavelength range, the total emission spectrum G′ or G″ is subject to a change w spectral power distribution as the tempera re increases, which produces a change of the color or of the color locus of the light emission.

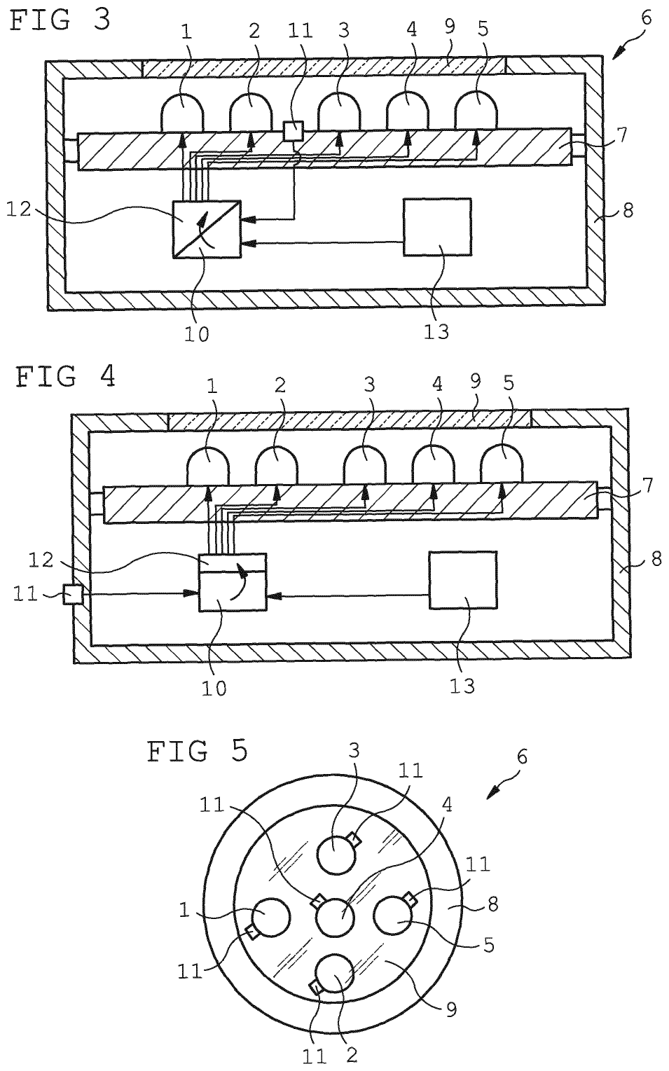

In a lighting device 6, illustrated in an exemplary manner and in different embodiments in FIGS. 3 to 5, the variety of light-emitting diodes 1 to 5 are arranged on a plate-shaped illuminant carrier 7. The illuminant carrier 7 is fastened in a housing 8 in such a way, that the individual light-emitting diodes 1 to 5 respectively emit a spectral power distribution through a window opening 9 in the housing 8 during operation thereof. Controlling the individual light-emitting diodes 1 to 5 occurs through a control device 10, which, depending on the respective control signals, supplies the individual light-emitting diodes 1 to 5 with a usually pulse-width modulated operating current. Due to the superimposition of the different light spectra of the individual light-emitting diodes 1 to 5, the desired color impression of the lighting device 6 is generated.

The spectral power distribution of the individual light-emitting diodes 1 to 5 depends on the respective operating temperature. With a change of the operating temperature of individual light-emitting diodes 1 to 5, which can for example be produced during operation of the lighting device 6 by the dissipation of heat of the individual light-emitting diodes 1 to 5 or also by a change in the ambient temperature, the light spectra and therefore also the spectral power distribution of the lighting device 6 would change if the control of light-emitting diodes 1 to 5 is maintained unchanged.

In order to be able to detect the current operating temperature as well as a change of the operating temperature within a predetermined detecting period, such as for example one minute, a temperature sensor 11 is arranged on the plate-shaped illuminant carrier 7 between the individual light-emitting diodes 1 to 5. The temperature sensor 11 transmits the measured temperature values to the control device 10, in which the individual measured temperature values are evaluated and transformed into current and actual temperature values as well as into temperature change information. The temperature change information can, for example, contain a temperature difference averaged throughout the detection period, an averaged temperature gradient or a course of the measured temperature values recorded through the detection period.

If either the newly determined actual temperature value or the temperature change information exceed or fall below a threshold value or leave a predefined range of difference to a previous actual temperature value or a previous temperature change information, the new control, signals are determined in a control signal generating step by means of the control device 10, and transmitted to an operating device 12 in a control step, said operating device providing the operating current for each of the light-emitting diodes 1 to 5, in order to keep the spectral power distribution during operation of the lighting device 6 as constant as possible.

For this purpose, start parameters PWMt0 for the control signals, which were determined in advance, e.g. by means of a Taylor series expansion depending on the temperature supporting points and stored in a memory device 13, are called from the memory device 13. Subsequently, a correction parameter Δpmw is determined using a suitable mathematic approximation method, in which a proportional fraction and an integral fraction are used with the approximation method for determining the correction parameter. The correction parameter is calculated on the basis of constants which have been determined in advance for a proportional fraction parameter P and an integral integral fraction parameter I, according to

Δpwm=P*ΔT(t−t0)+I∫ΔT(t)dt,

with ΔT(t=t0) designating the temperature difference between the actual temperature value detected between the start time and the supporting point temperature value, and ΔT(t) designating the change in temperature depending on the time throughout the detection period. From the start parameter PWMt0 and the correction parameter Δpwm, the new control signals are determined for the light-emitting diodes 1 to 5, which signals are transmitted to the operating device 12 and used for operation of the light-emitting diodes 1 to 5, until in a subsequent signal-generating step, altered control signals are generated and transmitted to the operating device 12.

In the exemplary embodiment schematically-illustrated in FIG. 3, the temperature sensor 11 is arranged on a top side on the plate-shaped illuminant carrier 7 between the individual light-emitting diodes 1 to 5. With this arrangement of the temperature sensor 11, the influence of an operating temperature defined by the heat dissipation of the light-emitting diodes 1-5 is dominant, whereas the influence of a heat-up or cool-down of the housing 8 caused by environmental influence is small. In addition, an average operating temperature of the light-emitting diodes 1 to 5 is measured by means of the one temperature sensor 8, wherein depending on the heat conductivity of the plate-shaped illuminant carrier 7, the influence of directly-neighboring light-emitting diodes 1 to 5 is greater than the influence of wider-spaced light-emitting diodes 1 to 5.

In the exemplary embodiment schematically-illustrated in FIG. 4, the temperature sensor 11 is arranged in a region of a side wall 14 of the housing 8 that faces away from the window opening 9. With this arrangement of the temperature sensor 11, the influence of an ambient temperature is higher and possibly dominant over the influence of the heat dissipation generated by light-emitting diodes 1 to 5 during operation. Such a configuration of the lighting device 6 is particularly expedient for illuminating devices which are mainly used outdoors and which are often subjected to frequent and strong temperature fluctuations of the ambient temperature or to a frequently changing solar irradiation. The temperature sensor 11 used according to the exemplary embodiment shown in FIG. 3 and the temperature sensor 11 used according to the exemplary embodiment shown in FIG. 4 can be referred to as ambient temperature sensor.

In the exemplary embodiment schematically-illustrated in FIG. 5, each light-emitting diode 1 to 5 has in each case one temperature sensor 11 assigned, which is arranged to directly be adjacent the respective light-emitting diode 1 to 5 and therefore individually and precisely detects an actual temperature value assigned to the respective light-emitting diode 1 to 5 as well as temperature change information for this light-emitting diode 1 to 5. With significantly differing operating temperatures for various types of light-emitting diodes 1 to 5, this configuration allows a very precise temperature control and, compared to an averaged temperature value of a single temperature sensor 11, the emission of a particularly constant spectral power distribution.

1. A method for controlling a lighting device with at least two illuminants having different emission characteristics, comprising
detecting, a detection step, at least one actual temperature value,
detecting, during a predeterminable detection period, at least one temperature-change information,
determining, in a control-signal generating step dependent upon the at least one detected actual temperature value and the at least one temperature-change information, new control signals for the respective control of the at least two illuminants for the emission oaf a predetermined spectral power distribution with the lighting device, and
transmitting, in a control step, the new control signals to an operating device, with which the operating current for each illuminant is provided, in order to keep the spectral power distribution emitted by the lighting device as constant as possible during the operation of the lighting device.

2. The method according to claim 1, wherein in the detection step, an operating temperature of the at least two illuminants is detected as the actual temperature value.

3. The method according to claim 1, wherein, in the detection step, an operating temperature for each illuminant is detected as an actual temperature value of the respective illuminant.

4. The method according to claim 1, wherein during the detection period in the detection step, a change of the ambient temperature is detected as the temperature change information.

5. The method according to claim 1, wherein during the detection period in the detection step, a change of at least one operating temperature of the illuminants is detected as the temperature change information.

6. The method according to claim 1, wherein in the control-signal-generating step, a start parameter is retrieved from a storage device for each illuminant depending on the at least one actual temperature value, that for each start parameter, a correction parameter is determined based on the at least one temperature-change information, and that the new control signals for the respective illuminant are generated from the start parameter and the correction parameter.

7. The method according to claim 6, wherein in the control-signal-generating step, the correction parameter is determined by means of a mathematical approximation method, in which a proportional fraction and an integral fraction are used in the approximation method to determine the correction parameter.

8. The method according to claim 7, wherein by means of simulations and/or by means of reference measurements performed in advance, a proportional fraction parameter and an integral fraction parameter are determined, which are used in the approximation method for determining the proportional fraction and the integral fraction.

9. The method according to claim 1, wherein in a selection step, the light spectrum of the lighting device is selected among a number of light spectra defined in advance, and is predetermined for a subsequent operating time.

10. Lighting device with at least two illuminants having different emission characteristics, with at least one temperature sensor, with a memory device and with a control device comprising a microprocessor, wherein the control device can read start parameters from the memory device of the lighting device, determine a correction parameter depending on at least one temperature change information measured by means of the temperature sensor, and transform the start parameters and the correction parameters into new control signals, and transmit these new control signals to an operating device of the lighting device, by which the operating current for each illuminant is provided, in order to keep the light spectrum emitted by the lighting device as constant as possible during operation of the lighting device.

11. The lighting device according to claim 10, wherein the lighting device comprises at least one ambient temperature sensor for detecting an ambient temperature of the lighting device and at least one operating temperature sensor for detecting the operating temperature of the illuminants in the vicinity of the illuminants.

12. The lighting device according to claim 10, wherein the lighting device comprises an operating temperature sensor for each illuminant and assigned to this illuminant.

13. The lighting device according to claim 10, wherein the lighting device comprises more than three different light-emitting diodes and among these, at least one light-emitting diode having a luminescent wavelength converter as the illuminant.
